(19) United States
(12) Patent Application Publication
(10) Pub. No.: US 2004/0059837 A1
(43) Pub. Date: Mar. 25, 2004

(54) Method and apparatus extending a server to a wireless-router server

(76) Inventor: Dennis Michael Volpano, Salinas, CA (US)

Correspondence Address: Glenn Patent Group, Suite L, 3475 Edison Way, Menlo Park, CA, 94025, US

(21) Appl. No.: 10/465,954

(22) PCT Filed: Apr. 17, 2001
(86) PCT No.: PCT/US01/12401

(51) Int. Cl. G06F 15/16

(52) U.S. Cl. 709/249

(57) ABSTRACT

A method and apparatus of providing communication between a wireless transceiver and a wireline network, wherein a wireless interface possessing a wireline communications port and the wireless transceiver is coupled to a server, wherein the server is further coupled to the wireline network. Certain embodiments preferably include techniques to extend a server to additionally function as a wireless router.

### TECHNICAL FIELD

This invention relates to providing a wireless interface as a server device to a server to create a wireless-router server.

### BACKGROUND ART

FIG. 1 depicts an 802.11 Extended Service Set as found in the prior art.

The components of a wireless Ethernet are defined in the IEEE Standard IEEE802. 11 Std-1999. The extended service set (ESS) of a wireless Ethernet comprises a distribution system (DS), mobile stations with wireless Ethernet transceivers (STA), and base stations, also known as access points (AP). A wireless Ethernet transceiver is typically packaged as a Type II PCMCIA card for use in contemporary notebook computers. Each AP is a link-layer (OSI layer 2) bridge between the DS and the STA. A high-rate ( 11 Mbps) wireless Ethernet standard utilizing Direct Sequence Spread Spectrum (DSSS) modulation is defined in the IEEE802.11b Standard.

The DS is normally a wired Ethernet (IEEE802.3 Standard). An AP behaves like an Ethernet hub or repeater. It relays Ethernet frames from the wired Ethernet to every STA as though the STA were physically attached to the wired Ethernet. It also relays every frame from an STA to the wired Ethernet. Multicast, broadcast, and unicast frames are relayed in both directions. An STA attaches to the DS through exactly one AP at any time. Movement of the STA may cause it to re-attach to the DS through a new AP. This constitutes a handoff of the STA between access points. Because an AP is a link-layer bridge, a handoff succeeds only if the base stations involved belong to the same OSI layer 3 subnet. It is not the responsibility of an AP to route at layer 3. The subnet to which a set of base stations belongs may have a gateway which routes layer 3 datagrams to other layer 3 subnets.

The IEEE802.11 Standard prescribes another form of wireless Ethernet called an Independent Basic Service Set (IBSS). Unlike the ESS, an IBSS has no DS and no AP. Mobile stations communicate directly. An IBSS is often called an ad hoc, or peer-to-peer, wireless network.

A router is characterized by multiple network interfaces. Each interface is associated with a set of destination addresses for devices that can be reached through that interface. The interface also has a unique address used to reference it.

For instance, an Ethernet interface is referenced by a 48-bit, layer 2 (link layer) address. It is also associated with a set of layer 2 addresses that is the set of destination addresses reachable from it. Each destination address corresponds to a device that can be reached via the Ethernet Medium Access Control (MAC) protocol through that physical interface. If Ethernet frames are routed between interfaces based on their destination layer 2 addresses, then routing occurs at layer 2. Layer 2 routers are commonly called switches.

However, routing can also occur at layer 3. When routing occurs at layer 3, each interface has a layer 3 address, and a range of destination layer 3 addresses. Layer 3 datagrams are routed between interfaces based on their destination layer 3 address.

If a physical network interface runs the IEEE802.11 MAC protocol (wireless Ethernet) and another runs the IEEE802.3 MAC protocol (wired Ethernet) then there are two ways to bridge the interfaces. One is at layer 3, and the other is at layer 2. The layer 3 bridge is called a wireless router. Wireless routers are not governed by the IEEE802.11 Standard. An AP is a layer 2, or link layer, bridge.

There is a wireless router available commercially, the SMC Networks Wireless Broadband Router. It has a wireless network transceiver, four physical ports, and a non-extensible set of services including firewall security and network address translation. The wireless network transceiver is integrated into the product, making its removal impossible.

FIG. 2 shows a typical configuration for a wireless router as found in the prior art.

The router has one interface connected to a DSL modem, another connected to a wired Ethernet hub, and a third physical interface that is a wireless Ethernet transceiver. Address translation done at the router permits multiple wired hosts, connected via the hub, and mobile stations, connected via the wireless transceiver, to share the single layer 3 address of the DSL interface. The wired hosts and mobile stations are behind the router in that wired hosts and mobile stations are allowed to connect to hosts on layer 3 subnets outside the subnet to which the layer 3 address of the DSL interface belongs. However, hosts on these other subnets cannot initiate a connection to any of the wired hosts or mobile stations. Network connections then are unidirectional due to network address translation.

Software that implements the functionality of an AP according to the IEEE802.11 Standard is available from Neesus Datacom. It is called PC-AP because it runs on a PC under Windows 95. It has three parts: an NDIS driver that controls a wireless Ethernet PC card, an NDIS driver for an IEEE802.3 wired Ethernet card, and a Windows protocol shim that bridges the two drivers at layer 2. Compaq has an OEM license to use PC-AP in its WL300 product.

As used herein server refers to at least one computer, with no particular size requirement, having one or more network interfaces through which clients (other computers) access message based services on the server. Such services include, but are not limited to, TCP/UDP protocol-based services. They may include, but are not limited to, file provisioning, print spooling, electronic mail, web content, datagram forwarding, and proxy services, among others. A server is extensible in that as part of its normal administration, new services can be enabled, and others disabled. A server is not normally tasked with routing even though server operating systems like Linux and FreeBSD can route at layer 3.

Current practice for accessing a server uses technology governed by the IEEE802.11 Standard to place the server in a DS and introduce an AP. Mobile wireless stations access the server indirectly through the AP using either TCP or UDP applications. Because services are TCP/UDP based, an alternative to using an AP to access the server is to use a wireless router instead. With either approach, a second processor, in the AP or router, is required to support mobile stations.

As used herein, a computer will refer to at least one of the following: an instruction processing system, an inference engine and a finite state machine. An instruction processing system will include at least one instruction register, whose contents will change through the fetching of instructions from a memory accessibly coupled to the computer.

Another example is a server that runs the Dynamic Host Configuration Protocol (DHCP). DHCP allows computers to dynamically discover the addresses of one or more authoritative domain name servers. Such information is also useful to mobile wireless stations.

But with a separate server and wireless router, DHCP will not see a mobile station's DHCP_DISCOVER packets because they are broadcast using the limited broadcast address, and a router never forwards a datagram whose destination address is the limited broadcast address. Hence the wireless router must also run DHCP, and maintain its own DHCP configuration file containing the addresses of the same domain name servers found in the DHCP configuration file on the server.

### SUMMARY OF THE INVENTION

The invention includes techniques extending a server to a wireless router. In certain preferred embodiments, only one computer is required, the server's computer.

Preferably, a PCMCIA Card Reader bridges a computer bus, such as PCI/ISA, and a Type II PCMCIA card providing the wireless interface. The PCMCIA Card reader is communicatively coupled to the server. A Type II PCMCIA wireless network transceiver is inserted into the Card Reader as the wireless interface. The server runs an operating system capable of forwarding layer 3 datagrams between its network interfaces, one of which is the wireless network interface.

There is economy in the invention besides eliminating a computer. Administration of the wireless router can be integrated with existing server configuration tasks. This provides opportunities to eliminate redundant processing and network/server administration. For instance, some commercial base stations allow filtering of Ethernet frames based on destination link-layer addresses. This is a capability that may already exist in the kernel running on the server. One can therefore use the tools and user interface of the operating system kernel to administer filtering across all network interfaces, wired as well as wireless.

As stated above with a separate server and wireless router, DHCP will not see a mobile station's DHCP_DISCOVER packets requiring the wireless router to also run DHCP, and maintain its own DHCP configuration file. This duplication is eliminated with the invention, as there is at most one instance of DHCP running, and only one configuration file.

The extended server merges the functions of a server and a wireless router. Usually they are sold separately as different pieces of hardware with separate operating systems and separate user interfaces for administration. The extended server has only one operating system and a single user interface for administering both the server's services and its wireless access capability.

Unlike any AP on the market today, the extended server is parameterized on the type of modulation. For example, the extended server can utilize FHSS (Bluetooth), DSSS (IEEE 802.11b) or OFDM (IEEE 802.11a). It's just a matter of using a different Type II PCMCIA wireless network card.

There are many applications that demand wireless access to a server. These are applications for which neither a server nor an AP nor a wireless router alone is sufficient. They include users, who may either be customers or service personnel, placing orders wirelessly in restaurants where menus are stored on the server. Allowing customers to wirelessly query a database stored on a server such as a library is another example. And yet another example is the delivery of audio and video content from the extended server, located in a kiosk, to automobiles and portable computers.

The extended server can provide Internet access wirelessly to handheld computers and personal digital assistants. It can update itself with new content downloaded periodically, or upon demand, from the Internet or from a site within an Extranet. Other places where the extended server is useful include bookstores, public libraries, coffee shops and convenience stores. All have in common the need for wireless access to a local repository of information for that site, plus wireless Internet access for information available only through the Internet.

The extended server can decapsulate packets for any communications protocol stack (e.g. WAP or Bluetooth). This facilitates integrating new protocol stacks that run on small wireless devices with existing networks. Interfacing with a new protocol stack is confined to the extended server, and hence to the network perimeter, leaving communication protocols in the existing network unmodified.

One of skill in the art will readily recognize that the embodiments of the invention disclosed herein will support more than one wireless interface and that different wireless interfaces may further support distinct wireless communications protocols. In a similar fashion, it will be recognized that multiple wireline communications ports can be coupled between the server and multiple wireline networks, possibly possessing different physical transport layers, as well as different messaging protocols.

These and other advantages of the present invention will become apparent upon reading the following detailed descriptions and studying the various figures of the drawings.

### BRIEF DESCRIPTION OF THE DRAWINGS

FIG. 1 depicts an 802.11 Extended Service Set as found in the prior art;

FIG. 2 shows a typical configuration for a wireless router as found in. the prior art;

FIG. 3A depicts a router supporting communications between a first wireless client 200 and a wireline network 110 using a server 100 operated by computer 150, which is controlled at least in part by program system 1000 residing in memory 160 accessibly coupled 152 to computer 150;

FIG. 3B depicts a router supporting communications between a first wireless client 200 and a wireline network 110 using a server 100 as in FIG. 3A operated by means 1000 for providing communication between transceiver 130 and wireline network 110;

FIG. 4 depicts a preferred wireless router using a server 100 operated by computer 150 as in FIG. 3A with wireless interface 120 embodied as a wireless PCMCIA card coupled 104 using the PCMCIA bus convention through PCMCIA card reader 170;

FIG. 5 depicts a detail flowchart of program system 1000 of FIG. 4A and means 1000 of FIG. 4B supporting communications between a first wireless client and a wireline network;

FIG. 6A depicts a detail flowchart of program system 1000 of FIG. 4A and means 1000 of FIG. 4B further supporting communications between a wireless client and a wireline network;

FIG. 6B depicts a detail flowchart of operation 1082 of FIG. 6A further showing the wireless client communicating via the wireless coupling;

FIG. 7A depicts a detail flowchart of operation 1022 of FIG. 5 further enabling address translation on the server;

FIG. 7B depicts a detail flowchart of operation 1032 of FIG. 5 further adding the network route for the wireless interface on the server;

FIG. 8 depicts a detail flowchart of operation 1042 of FIG. 5 further making the wireless interface available to at least one wireless client; and

FIG. 9 depicts a detail flowchart of operation 2000 of the technique extending a server to a wireless router.

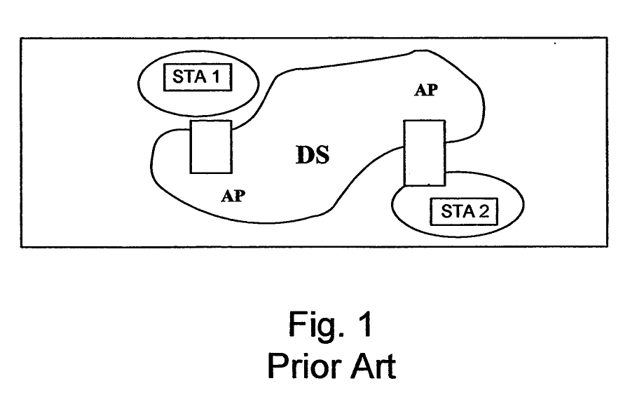

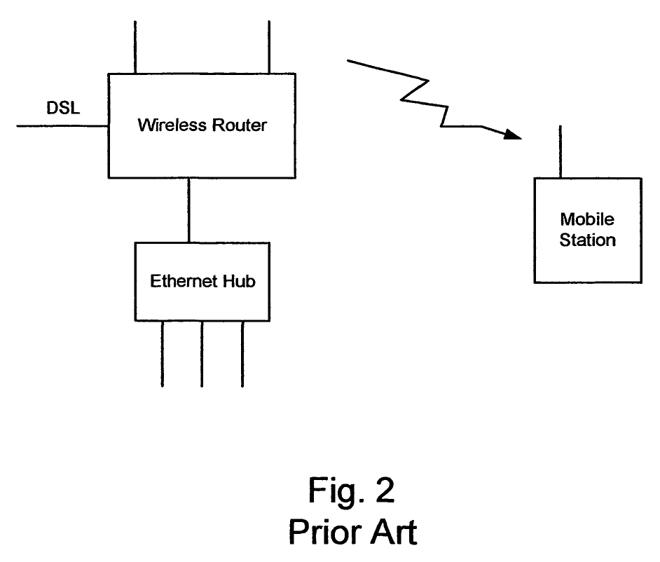

### DETAILED DESCRIPTION OF THE INVENTION

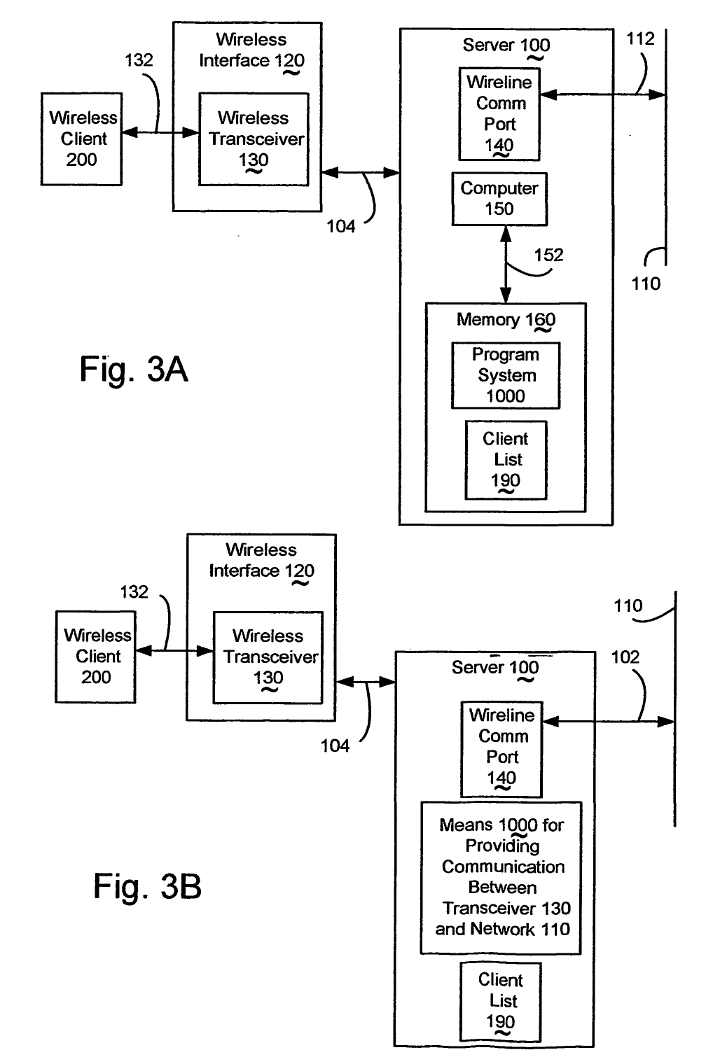

FIG. 3A depicts a wireless router supporting communications between a first wireless client 200 and a wireline network 110 using a server 100 operated by computer 150, which is controlled at least in part by program system 1000 residing in memory 160 accessibly coupled 152 to computer 150.

The system is comprised of a wireless interface 120 coupled 104 to a server 100 which couples 112 via wireline communication port 140 to wireline network 110. The wireless interface 120 possesses a wireless transceiver 130. The wireless interface 120 may preferably couple 104 via a PCMCIA card reader 170 communicatively coupled 154 with computer 150.

The wireline network 110 couples 112 via wireline communications port 140 to the server 100. Note the wireline communications port 140 may include a bus port.

The server is controlled by at least one computer 150 operating the server 100 based upon a program system 1000 comprising program steps residing in memory 160 accessibly coupled 152 with the computer 150.

Wireless transceivers 120 may support at least a message passing wireless communications protocol, further supporting at least layer two messaging communications protocols. Wireless transceivers 120 preferably support at least IEEE 802.11b.

Routers embodied in this invention preferably support layer three datagrams originating from wireless users.

FIG. 3B depicts a wireless router supporting communications between a first wireless client 200 and a wireline network 110 using a server 100 as in FIG. 3A operated by means 1000 for providing communication between transceiver 130 and wireline network 110.

Means 1000 implements the methods of this invention using operational controls including, but not limited to, instruction processors, inferential engines, neural networks, and finite state machines, which may or may not be one-hot-state encoded. The means for implementing individual steps of the methods of this invention may be differ from one step to another. The means for implementing groups of these steps may use a single control mechanism. Note that in contemporary technology, the preferred means for implementing these operations is as program steps residing in memory, but that even now, when the volume of use of an invention becomes large enough, any or all of the mentioned means have been used to advantage in other systems.

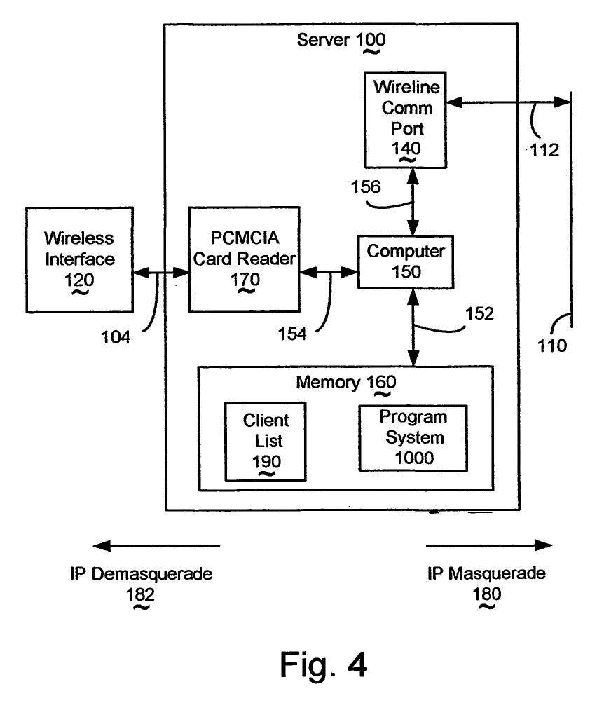

FIG. 4 depicts a preferred wireless router using a server 100 operated by computer 150 as in FIG. 3A with wireless interface 120 embodied as a wireless PCMCIA card coupled 104 using the PCMCIA bus convention through PCMCIA card reader 170.

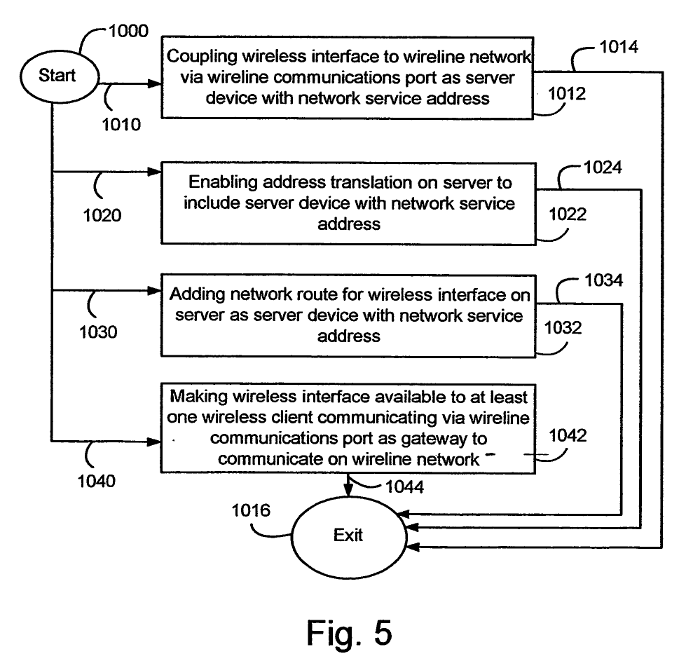

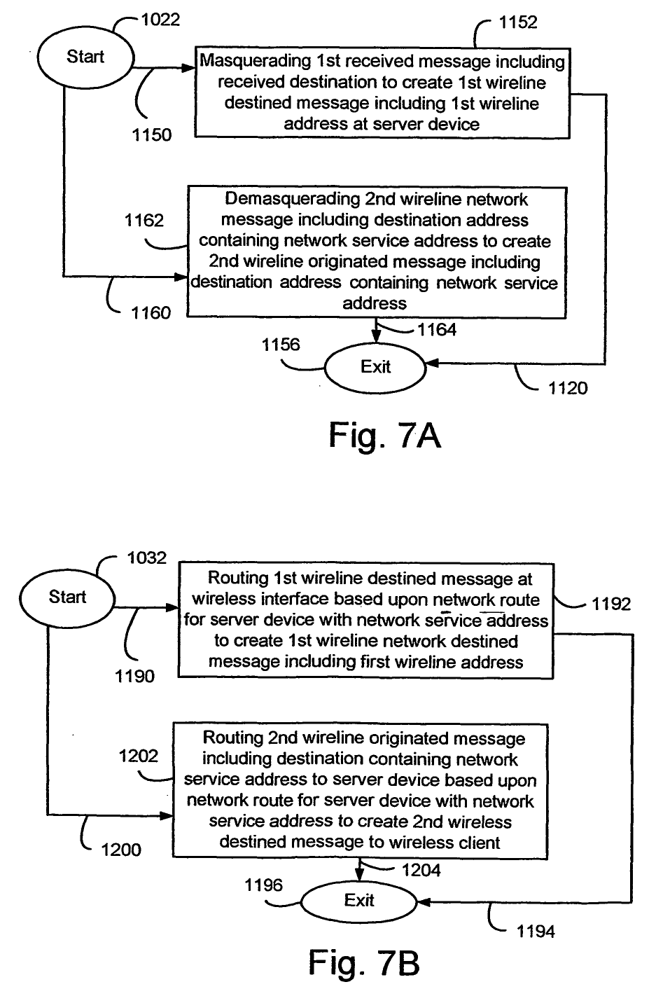

Network address translation is accomplished by running IP masquerade 180, which masquerades traffic from the wireless to the wired interface, and demasquerades 182 return traffic from the wired to the wireless interface. Network address translation is discussed in FIG. 5 as operation 1022. As used herein, masquerading traffic may refer to the use of a single or the use of multiple external addresses for traffic through a wireless router constructed in accordance with this invention. The masquerading and demasquerading operations 180 and 182 are further discussed in FIG. 7A as operations 1152 and 1162, respectively.

This implies that the wireless router 100 forwards layer 3 datagrams to and from mobile wireless clients 200. It is not necessary to perform address translation to extend a server 100 to a wireless router. The key property is that the server 100 be able to forward datagrams. Address translation allows multiple wireless clients 200 to each have a unique unicast layer 3 address and yet all be represented by the server 100 with just a single unicast address on the wireline network 110.

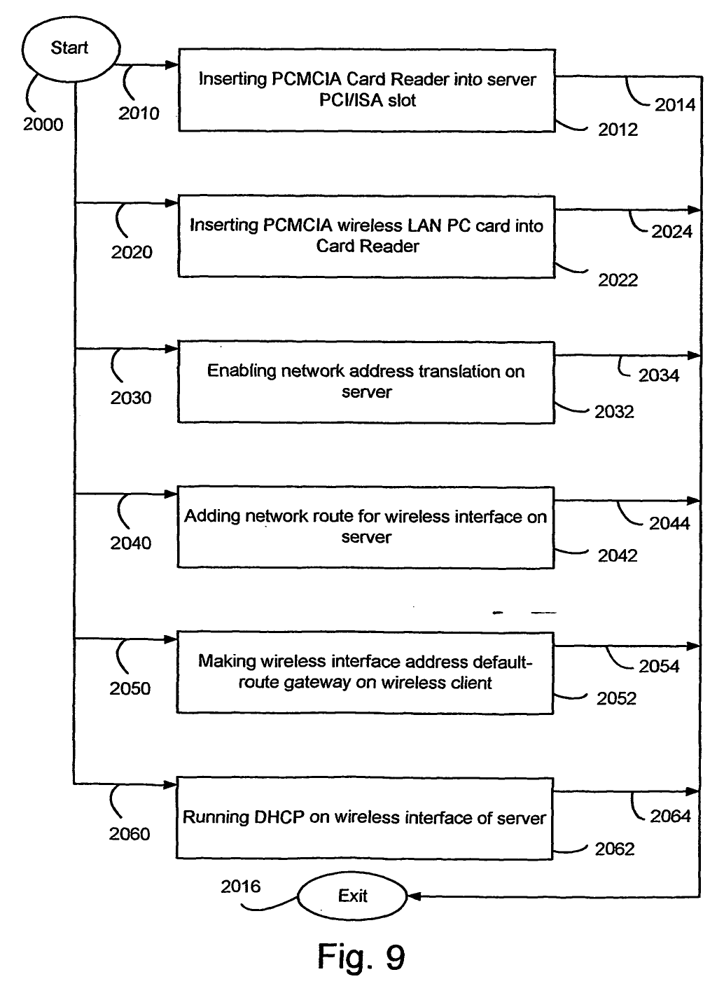

Operation 1032 of FIG. 5 and operation 2032 of FIG. 9 involve adding a subnet route to the kernel routing table of the server 100 with the wireless interface 120 as its device.

FIG. 5 depicts a detail flowchart of program system.1000 of FIG. 4A and means 1000 of FIG. 4B supporting communications between a first wireless client and a wireline network.

Arrow 1010 directs the flow of execution from starting operation 1000 to operation 1012. Operation 1012 performs coupling the wireless interface to the wireline network via the wireline communications port as a server device with a network service address. Arrow 1014 directs execution from operation 1012 to operation 1016. Operation 1016 terminates the operations of this flowchart.

Arrow 1020 directs the flow of execution from starting operation 1000 to operation 1022. Operation 1022 performs enabling address translation on the server to include the server device with the network service address. Arrow 1024 directs execution from operation 1022 to operation 1016. Operation 1016 terminates the operations of this flowchart.

Arrow 1030 directs the flow of execution from starting operation 1000 to operation 1032. Operation 1032 performs adding a network route for the wireless interface on the server as a server device with the network service address. Arrow 1034 directs execution from operation 1032 to operation 1016. Operation 1016 terminates the operations of this flowchart.

Arrow 1040 directs the flow of execution from starting operation 1000 to operation 1042. Operation 1042 performs making the wireless interface available to at least one wireless client communicating via the wireline communications port as a gateway to communicate on the wireline network. Arrow 1044 directs execution from operation .1042 to operation 1016. Operation 1016 terminates the operations of this flowchart.

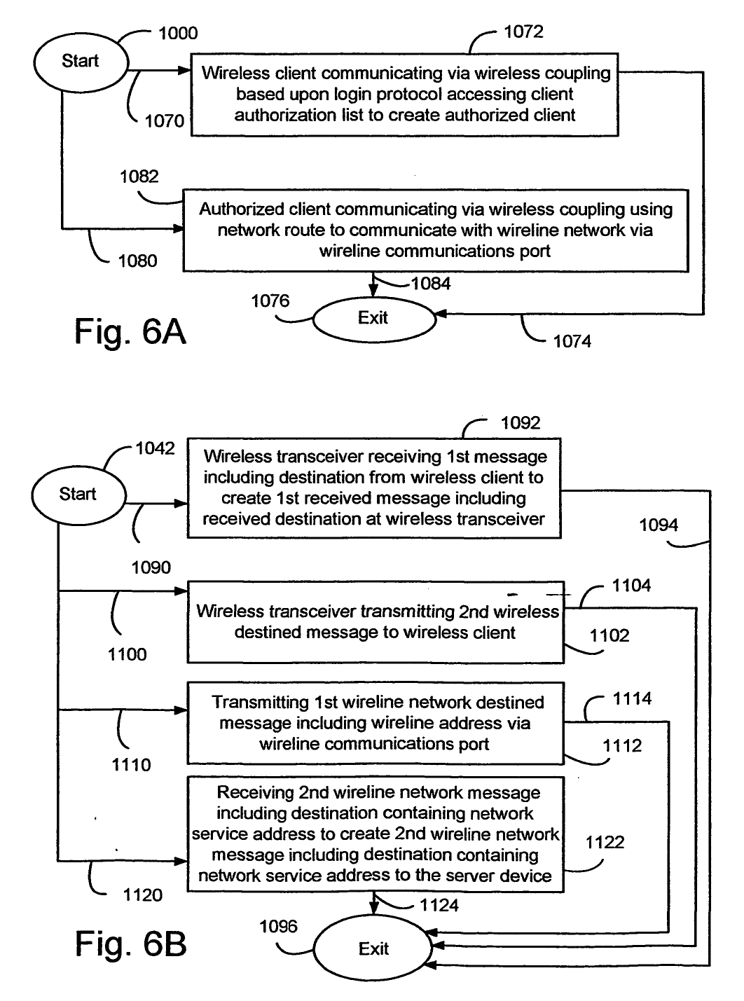

FIG. 6A depicts a detail flowchart of program system 1000 of FIG. 4A and means 1000 of FIG. 4B further supporting communications between a wireless client and a wireline network.

Arrow 1070 directs the flow of execution from starting operation 1000 to operation 1072. Operation 1072 performs a wireless client communicating via the wireless coupling based upon a login protocol accessing a client authorization list to create an authorized client. Arrow 1074 directs execution from operation 1072 to operation 1076. Operation 1076 terminates the operations of this flowchart.

Arrow 1080 directs the flow of execution from starting operation 1000 to operation 1082. Operation 1082 performs the authorized client communicating via the wireless coupling using the network route to communicate with the wireline network via the wireline communications port. Arrow 1084 directs execution from operation 1082 to operation 1076. Operation 1076 terminates the operations of this flowchart.

FIG. 6B depicts a detail flowchart of operation 1042 of FIG. 5 further making the wireless interface available to the authorized client.

Arrow 1090 directs the flow of execution from starting operation 1042 to operation 1092. Operation 1092 performs the wireless transceiver receiving a first message including a destination from the wireless client to create a first received message including the received destination at the wireless transceiver. Arrow 1094 directs execution from operation 1092 to operation 1096. Operation 1096 terminates the operations of this flowchart.

Arrow 1100 directs the flow of execution from starting operation 1042 to operation 1102. Operation 11 02 performs the wireless transceiver transmitting a second wireless destined message to the wireless client. Arrow 1104 directs execution from operation 1102 to operation 1096. Operation 1096 terminates the operations of this flowchart.

Arrow 1110 directs the flow of execution from starting operation 1042 to operation 1112. Operation 1112 performs transmitting the first wireline network destined message including the wireline address via the wireline communications port. Arrow 1114 directs execution from operation 1112 to operation 1096. Operation 1096 terminates the operations of this flowchart.

Arrow 1120 directs the flow of execution from starting operation 1042 to operation 1122. Operation 1122 performs receiving a second wireline network message including a destination containing the network service address to create a second wireline network message including the destination containing the network service address to the server device. Arrow 1124 directs execution from operation 1122 to operation 1096. Operation 1096 terminates the operations of this flowchart.

Certain embodiments of the invention include just one pair of the performed operations 1092-1112 and 1102-1122, even though it is preferable in most embodiments to perform both of these pairs of operations.

FIG. 7A depicts a detail flowchart of operation 1022 of FIG. 5 further enabling address translation on the server.

Arrow 1150 directs the flow of execution from starting operation 1022 to operation 1152. Operation 1152 performs masquerading the first received message including the received destination to create a first wireline destined message including a first wireline address at the server device. Arrow 1154 directs execution from operation 1152 to operation 1156. Operation 1156 terminates the operations of this flowchart.

Arrow 1160 directs the flow of execution from starting operation 1022 to operation 1162. Operation 1162 performs demasquerading a second wireline network message including the destination address containing the network service address to create the second wireline originated message including the destination address containing the network service address. Arrow 1164 directs execution from operation 1162 to operation 1156. Operation 1156 terminates the operations of this flowchart.

FIG. 7B depicts a detail flowchart of operation 1032 of FIG. 5 further adding the network route for the wireless interface on the server.

Arrow 1190 directs the flow of execution from starting operation 1032 to operation 1192. Operation 1192 performs routing the first wireline destined message at the wireless interface based upon the network route for the server device with the network service address to create a first wireline network destined message including the first wireline address. Arrow 1194 directs execution from operation 1192 to operation 1196. Operation 1196 terminates the operations of this flowchart.

Arrow 1200 directs the flow of execution from starting operation 1032 to operation 1202. Operation 1202 performs routing a second wireline originated message including a destination containing the network service address to the server device based upon the network route for the server device with the network service address to create the second wireless destined message to the wireless client. Arrow 1204 directs execution from operation 1202 to operation 1196. Operation 1196 terminates the operations of this flowchart.

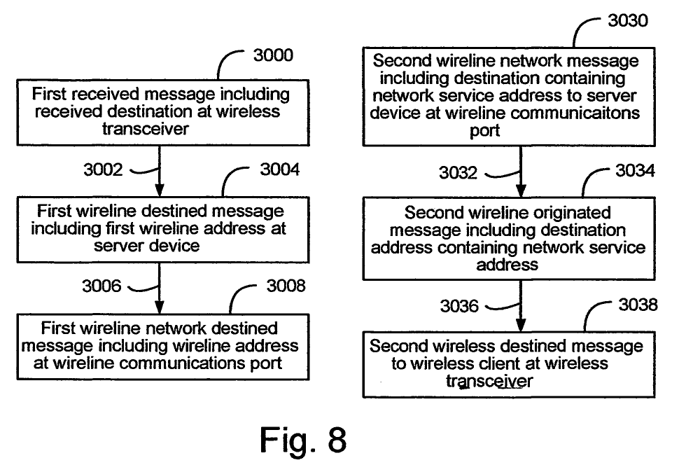

FIG. 8 depicts a portrayal of the data flow from reception of messages at the wireless transceiver and wireline communications port to the transmission of messages at the wireline communications port and wireless transceiver, respectively.

Box 3000 depicts the first received message including received destination at wireless transceiver 130. Arrow 3002 depicts the operation of masquerading to create box 3004. Box 3004 depicts the first wireline destined message including a first wireline address at the server device. Arrow 3006 depicts the operation of routing to create box 3008.

Box 3008 depicts the first wireline network destined message including the wireline address at the wireline communications port 140.

Box 3030 depicts the second wireline network message including destination containing network service address to server device at the wireline communicaitons port 140. Arrow 3032 depicts the operation of demasquerading to create box 3034.

Box 3034 depicts the second wireline originated message including destination address containing network service address. Arrow 3036 depicts the operation of routing to create box 3038.

Box 3038 depicts the second wireless destined message to the wireless client 200 at the wireless transceiver 130.

The invention includes a technique that extends a server to a wireless router. Certain embodiments of the invention preferably require the server to run an operating system capable of layer 3 datagram forwarding, like Linux or FreeBSD, and to have an unused Peripheral Component Interconnect (PCI) or Industry Standard Architecture (ISA) bus slot on its motherboard.

FIG. 9 depicts a detail flowchart of operation 2000 of the technique extending a server to a wireless router.

Arrow 2010 directs the flow of execution from starting operation 2000 to operation 2012. Operation 2012 performs inserting a PCMCIA Card Reader into a server PCI/ISA slot. Arrow 2014 directs execution from operation 2012 to operation 2016. Operation 2016 terminates the operations of this flowchart.

Arrow 2020 directs the flow of execution from starting operation 2000 to operation 2022. Operation 2022 performs inserting a PCMCIA wireless LAN PC card into the Card Reader. Arrow 2024 directs execution from operation 2022 to operation 2016. Operation 2016 terminates the operations of this flowchart.

Arrow 2030 directs the flow of execution from starting operation 2000 to operation 2032. Operation 2032 performs enabling network address translation on the server. Arrow 2034 directs execution from operation 2032 to operation 2016. Operation 2016 terminates the operations of this flowchart.

Arrow 2040 directs the flow of execution from starting operation 2000 to operation 2042. Operation 2042 performs adding a network route for the wireless interface on the server. Arrow 2044 directs execution from operation 2042 to operation 2016. Operation 2016 terminates the operations of this flowchart.

Arrow 2050 directs the flow of execution from starting operation 2000 to operation 2052. Operation 2052 performs making the wireless interface address a default-route gateway on wireless clients. Arrow 2054 directs execution from operation 2052 to operation 2016. Operation 2016 terminates the operations of this flowchart.

Arrow 2060 directs the flow of execution from starting operation 2000 to operation 2062. Operation 2062 performs running DHCP on the wireless interface of the server. Arrow 2064 directs execution from operation 2062 to operation 2016. Operation 2016 terminates the operations of this flowchart.

Operation 2062 requires an entry in the DHCP configuration file of the server of the form “option routers ip_addr;” where ip_addr is the ip_addr of the wireless interface. This entry guarantees that wireless clients running a DHCP client, such as “dhcpcd” or “pump”, can configure their routing tables with a default routing entry that has ip_addr as the gateway. Address ip_addr is known to the wireless clients through DHCP offers they receive in response to their DHCP discover packets. A DHCP server runs on the server, and a DHCP client runs on every wireless client. Thus, every wireless client is fully configured to use the server by running only a standard DHCP client. No additional wireless client software is required.

The preceding embodiments have been provided by way of example and are not meant to constrain the scope of the following claims.

1. A wireless router supporting communications between a wireless client and a wireline network comprising:
a wireless interface coupled to a server and possessing a wireless transceiver;
said wireline network coupled to said server via a wireline communications port;
at least one computer operating said server based upon a program system comprising program steps residing in memory accessibly coupled with said computer;
wherein said program system is comprised of the program steps of:
coupling said wireless interface to said wireline network via said wireline communications port as a server device with a network service address;
enabling address translation on said server to include said server device with said network service address;
adding a network route for said wireless interface on said server for said server device with said network service address; and
making said wireless interface available to at least one wireless client communicating via said wireless coupling as a gateway to communicate on said wireline network;
a wireless client communicating via said wireless coupling based upon a login protocol accessing a client authorization list to create an authorized client; and
said authorized client communicating via said wireless coupling using said network route to communicate with said wireline network via said wireline communications port;
wherein the program step making said wireless interface available to said wireless client is further comprised of the program steps of:
said wireless transceiver receiving a first message including a destination from said wireless client to create a first received message including said received destination at said wireless transceiver;
said wireless transceiver transmitting a second wireless destined message to said wireless client;
transmitting said first wireline network destined message including said wireline address via said wireline communications port; and
receiving a second wireline network message including a destination containing said network service address to create a second wireline network message including said destination containing said network service address to said server device;
wherein the program step enabling address translation on said server is further comprised of the program steps of:
masquerading said first received message including said received destination to create a first wireline destined message including a first wireline address at said server device; and
demasquerading a second wireline network message including said destination address containing said network service address to create said second wireline originated message including said destination address containing said network service address;
wherein the program step adding said network route for said wireless interface on said server is further comprised of the program steps of:
routing said first wireline destined message at said wireless interface based upon said network route for said server device with said network service address to create a first wireline network destined message including said first wireline address; and
routing a second wireline originated message including a destination containing said network service address to said server device based upon said network route for said server device with said network service address to create said second wireless destined message to said wireless client;
wherein said wireless transceiver further supports at least the IEEE802.11b messaging protocol standard in communicating with said wireless client.

2. The wireless router of claim 1,
wherein said wireless interface further supports at least the IEEE802.11a messaging protocol standard in communicating with said wireless client.

3. The wireless router of claim 1,
wherein said wireless interface further supports at least a layer three messaging protocol in communicating with said wireless client including said server supporting layer three datagrams.

4. The wireless router of claim 3,
wherein said wireless interface further supports a messaging protocol compatible with WAP in communicating with said wireless client.

5. A method of providing communication between a wireless transceiver and a wireline network, wherein a wireless interface possessing a wireline communications port and said wireless transceiver is coupled to a server, wherein said server is further coupled to said wireline network comprising the steps of:
coupling said wireless interface to said wireline network via said wireline communications port as a server device with a network service address;
enabling address translation on said server to include said server device with said network service address;
adding a network route for said wireless interface on said server for is said server device with said network service address; and
making said wireless interface available to at least one wireless client communicating via said wireless coupling as a gateway to communicate on said wireline network; and
a wireless client communicating via said wireless coupling based upon a login protocol accessing a client authorization list to create an authorized client; and
said authorized client communicating via said wireless coupling using said network route to communicate with said wireline network; and
wherein the step making said wireless interface available to said wireless client is further comprised of the steps of:
said wireless transceiver receiving a first message including a destination from said wireless client to create a first received message including said received destination at said wireless transceiver;
said wireless transceiver transmitting a second wireless destined message to said wireless client;
transmitting said first wireline network destined message including said wireline address via said wireline communications port; and
receiving a second wireline network message including a destination containing said network service address to create a second wireline network message including said destination containing said network service address to said server device;
wherein the step enabling address translation on said server is further comprised of the steps of:
masquerading said first received message including said received destination to create a first wireline destined message including a first wireline address at said server device; and
demasquerading a second wireline network message including said destination address containing said network service address to create said second wireline originated message including said destination address containing said network service address;
wherein the step adding said network route for said wireless interface on said server is further comprised of the steps of:
routing said first wireline destined message at said wireless interface based upon said network -route for said server device with said network service address to create a first wireline network destined message including said first wireline address; and
routing a second wireline originated message including a destination containing said network service address to said server device based upon said network route for said server device with said network service address to create said second wireless destined message to said wireless client;
wherein said wireless transceiver further supports at least the IEEE802.11b messaging protocol standard in communicating with said wireless client.

6. Said first wireline network destined messages including said wireline address as created by the process of claim 5.

7. Said second wireless destined messages to said authorized client as created by the process of claim 5.

8. The method of claim 5,
wherein said wireless transceiver further supports at least the IEEE802.11a messaging protocol standard in communicating with said wireless client.

9. The method of claim 5,
wherein said wireless transceiver further supports at least a layer three messaging protocol in communicating with said wireless client including said server supporting layer three datagrams.

10. The method of claim 9,
wherein said wireless transceiver further supports a messaging protocol compatible with WAP in communicating with said wireless client.

11. A program system implementing the steps of the method of claim 5 as program steps residing in at least one memory accessibly coupled with a computer operating said server.

12. A method of providing communication between a wireless transceiver and a wireline network, wherein a wireless interface possessing said wireless transceiver is coupled to a server further coupled via a wireline communications port to said wireline network, comprising the steps of:
coupling said wireless interface to said wireline network via said wireline communications port as a server device with a network service address;
enabling address translation on said server to include said server device with said network service address;
adding a network route for said wireless interface on said server for said server device with said network service address; and
making said wireless interface available to at least one wireless client communicating via said wireless coupling as a gateway to communicate on said wireline network.

13. The method of claim 12, further comprising the steps of:
a wireless client communicating via said wireless coupling based upon a login protocol accessing a client authorization list to create an authorized client; and
said authorized client communicating via said wireless coupling using said network route to communicate with said wireline network.

14. The method of claim 12,
wherein the step making said wireless interface available to said authorized client is further comprised of the steps of:
said wireless transceiver receiving a first message including a destination from said wireless client to create a first received message including said received destination at said wireless transceiver;
said wireless transceiver transmitting a second wireless destined message to said wireless client;
transmitting said first wireline network destined message including said wireline address via said wireline communications port; and
receiving a second wireline network message including a destination containing said network service address to create a second wireline network message including said destination containing said network service address to said server device;
wherein the step enabling address translation on said server is further comprised of the steps of:
masquerading said first received message including said received destination to create a first wireline destined message including a first wireline address at said server device; and
demasquerading a second wireline network message including said destination address containing said network service address to create said second wireline originated message including said destination address containing said network service address;
wherein the step adding said network route for said wireless interface on said server is further comprised of the steps of:
routing said first wireline destined message at said wireless interface based upon said network route for said server device with said network service address to create a first wireline network destined message including said first wireline address; and
routing a second wireline originated message including a destination containing said network service address to said server device based upon said network route for said server device with said network service address to create said second wireless destined message to said wireless client.

15. Said first wireline network destined messages as created by the process of claim 14.

16. Said second wireless destined messages as created by the process of claim 14.

17. The method of claim 12,
wherein said wireless interface supports a message passing communications protocol in communicating with said wireless client.

18. The method of claim 17,
wherein said wireless transceiver further supports at least a layer two messaging protocol in communicating with said wireless client.

19. The method of claim 18,
wherein said wireless transceiver further supports at least the IEEE802.11b messaging protocol standard in communicating with said wireless client.

20. The method of claim 18,
wherein said wireless transceiver further supports at least the IEEE802.11a messaging protocol standard in communicating with said wireless client.

21. The method of claim 18,
wherein said wireless interface further supports at least a layer three messaging protocol in communicating with said wireless client including said server supporting layer three datagrams.

22. The method of claim 21,
wherein said wireless transceiver further supports a messaging protocol compatible with WAP in communicating with said wireless client.

23. A program system implementing the steps of the method of claim 12 as program steps residing in at least one memory accessibly coupled with a computer operating said server.

24. A wireless router supporting communications between a wireless client and a wireline network comprising:
a wireless interface coupled to a server and possessing a wireless transceiver;
said wireline network coupled to said server via a wireline communications port;
at least one computer operating said server based upon a program system comprising program steps residing in memory accessibly coupled with said computer;
wherein said program system is comprised of the program steps of:
coupling said wireless interface to said wireline network via said wireline communications port as a server device with a network service address;
enabling address translation on said server to include said server device with said network service address;
adding a network route for said wireless interface on said server for said server device with said network service address; and
making said wireless interface available to at least one wireless client communicating via said wireless coupling as a gateway to communicate on said wireline network.

25. The wireless router of claim 24,
wherein said program system further comprising the program steps of:
a wireless client communicating via said wireless coupling based upon a login protocol accessing a client authorization list to create an authorized client; and
said authorized client communicating via said wireless coupling using said network route to communicate with said wireline network.

26. The wireless router of claim 24,
wherein the program step making said wireless interface available to said wireless client is further comprised of the program steps of:
said wireless transceiver receiving a first message including a destination from said wireless client to create a first received message including said received destination at said wireless transceiver;
said wireless transceiver transmitting a second wireless destined message to said wireless client;
transmitting said first wireline network destined message including said wireline address via said wireline communications port; and
receiving a second wireline network message including a destination containing said network service address to create a second wireline network message including said destination containing said network service address to said server device;
wherein the program step enabling address translation on said server is further comprised of the program steps of:
masquerading said first received message including said received destination to create a first wireline destined message including a first wireline address at said server device; and
demasquerading a second wireline network message including said destination address containing said network service address to create said second wireline originated message including said destination address containing said network service address;
wherein the program step adding said network route for said wireless interface on said server is further comprised of the program steps of:
routing said first wireline destined message at said wireless interface based upon said network route for said server device with said network service address to create a first wireline network destined message including said first wireline address; and
routing a second wireline originated message including a destination containing said network service address to said server device based upon said network route for said server device with said network service address to create said second wireless destined message to said wireless client.

27. The wireless router of claim 24,
wherein said wireless interface supports a message passing communications protocol in communicating with said wireless client.

28. The wireless router of claim 27,
wherein said wireless transceiver further supports at least a layer two messaging protocol in communicating with said wireless client.

29. The wireless router of claim 28,
wherein said wireless interface further supports at least the IEEE802.11b messaging protocol standard in communicating with said wireless client.

30. The wireless router of claim 28,
wherein said wireless interface further supports at least the IEEE802.11a messaging protocol standard in communicating with said wireless client.

31. The wireless router of claim 28,
wherein said wireless interface further supports at least a layer three messaging protocol in communicating with said wireless client including said server supporting layer three datagrams.

32. The wireless router of claim 31,
wherein said wireless interface further supports a messaging protocol compatible with WAP in communicating with said wireless client.

33. A wireless router supporting communications between a wireless client and a wireline network comprising:
a wireless interface coupled to a server and possessing a wireless transceiver;
said wireline network coupled to said server via a wireline communications port;
wherein said server is comprised of:
means for coupling said wireless interface to said wireline network via said wireline communications port as a server device with a network service address;
means for enabling address translation on said server to include said server device with said network service address;
means for adding a network route for said wireless interface on said server for said server device with said network service address; and
means for making said wireless interface available to at least one wireless client communicating via said wireless coupling as a gateway to communicate on said wireline network;
means for a wireless client communicating via said wireless coupling based upon a login protocol accessing a client authorization list to create an authorized client; and
means for said authorized client communicating via said wireless coupling using said network route to communicate with said wireline network;
wherein the means for making said wireless interface available to said wireless client is further comprised of:
means for said wireless transceiver receiving a first message including a destination from said wireless client to create a first received message including said received destination at said wireless transceiver;
means for said wireless transceiver transmitting a second wireless destined message to said wireless client;
means for transmitting said first wireline network destined message including said wireline address via said wireline communications port; and
means for receiving a second wireline network message including a destination containing said network service address to create a second wireline network message including said destination containing said network service address to said server device;
wherein the means for enabling address translation on said server is further comprised of:
means for masquerading said first received message including said received destination to create a first wireline destined message including a first wireline address at said server device; and
means for demasquerading a second wireline network message including said destination address containing said network service address to create said second wireline originated message including said destination address containing said network service address;
wherein the means for adding said network route for said wireless interface on said server is further comprised of:
means for routing said first wireline destined message at said wireless interface based upon said network route for said server device with said network service address to create a first wireline network destined message including said first wireline address; and
means for routing a second wireline originated message including a destination containing said network service address to said server device based upon said network route for said server device with said network service address to create said second wireless destined message to said wireless client;
wherein said wireless transceiver further supports at least the IEEE802.11b messaging protocol standard in communicating with said wireless client.

34. The wireless router of claim 33,
wherein said wireless interface further supports at least the IEEE802.11a messaging protocol standard in communicating with said wireless client.

35. The wireless router of claim 33,
wherein said wireless interface further supports at least a layer three messaging protocol in communicating with said wireless client including said server supporting layer three datagrams.

36. The wireless router of claim 35,
wherein said wireless interface further supports a messaging protocol compatible with WAP in communicating with said wireless client.

37. A method of technique extending a server to a wireless router comprising the steps of:
coupling a wireless interface to said server;
enabling network address translation on said server;
adding a network route for said wireless interface on said server to create a wireless interface address;
making said wireless interface address a default-route gateway for a wireless user communicating via said wireless interface; and running DHCP on said wireless interface by said server.

38. The method of claim 37,
wherein said wireless interface is a PCMCIA wireless LAN PC card;
wherein the step coupling said wireless interface is further comprised of the steps of:
inserting a PCMCIA Card Reader into a PCI/ISA slot coupled with said server; and
inserting said PCMCIA wireless LAN PC card into said Card Reader.
